(19) United States
(12) Patent Application Publication
(10) Pub. No.: US 2006/0027604 A1
(43) Pub. Date: Feb. 9, 2006

(54) Pressure regulator and dispensing device

(76) Inventor: Daniel Puzio, Baltimore, MD (US)

Correspondence Address: HARNESS, DICKEY & PIERCE, P.L.C., P.O. BOX 828, BLOOMFIELD HILLS, MI, 48303, US

(21) Appl. No.: 10/912,767

(22) Filed: Aug. 5, 2004

(51) Int. Cl. G01F 11/00

(52) U.S. Cl. 222/263

(57) ABSTRACT

A pressure regulator includes a regulated pressure gas enclosure and a valve associated with a source of high pressure gas. The valve has an actuator that, when depressed, releases high pressure gas from the source into the regulated pressure gas enclosure. A piston is located adjacent the actuator of the valve. The piston is adapted to move the actuator into an open position permitting high pressure gas to pass into the regulated gas pressure enclosure through the valve in response to a reduced gas pressure level in the regulated pressure gas enclosure. The piston is also adapted to permit the actuator to move into a closed position in response to an increased gas pressure level within the regulated pressure gas enclosure. A dispensing device incorporates the pressure regulator. The dispensing device is adapted to be driven by a CO₂ gas cartridge and to dispense viscous product from a product cartridge.

### FIELD OF THE INVENTION

The present invention relates to pressure regulators; and more particularly, to pressure regulators for gas cartridge driven devices.

### BACKGROUND OF THE INVENTION

In general, pressure regulators receive an input of relatively high pressure gas and output the gas at a relatively low pressure. As the pressure drops on the relatively low pressure side of the pressure regulator, additional gas is passed through the pressure regulator to maintain the relatively low pressure. In this way, a source of high pressure gas can be used to drive devices that require only a fraction of the high pressure to operate properly. Exemplary sources of high pressure gas include, for example, tanks of compressed air, aerosol containers and commercially available CO₂ gas cartridges.

Unfortunately, pressure regulators can be quite costly. The cost of a pressure regulator can become significant in relation to the overall cost of the device into which it is incorporated. This can be true, for example, in relation to dispensing devices for dispensing a viscous product from a viscous product cartridge. Such viscous product cartridges are commonly used in association with adhesives, caulks and other sealants. Thus, it has been discovered that a low cost, reliable pressure regulator is desirable; particularly for use in dispensing devices for dispensing a viscous product from a viscous product cartridge.

### SUMMARY OF THE INVENTION

In accordance with one aspect of the present invention, a pressure regulator is provided. The pressure regulator includes a regulated pressure gas enclosure. A valve is associated with a source of high pressure gas. The valve has an actuator that, when depressed, releases high pressure gas from the source into the regulated pressure gas enclosure. A piston is located adjacent the actuator of the valve. The piston is adapted to move the actuator into an open position permitting high pressure gas to pass into the regulated gas pressure enclosure through the valve in response to a reduced gas pressure level in the regulated pressure gas enclosure. The piston is also adapted to permit the actuator to move into a closed position in response to an increased gas pressure level within the regulated pressure gas enclosure.

In accordance with another aspect of the present invention, a device for dispensing a viscous product from a viscous product cartridge is provided. The dispensing device is adapted to be driven by a pressurized gas cartridge. A product housing component is adapted to retain the viscous product cartridge and to cooperate with the viscous product cartridge to form a gas enclosure separated from a product enclosure by a movable wall. A fluid passage provides fluid communication between an inlet and the gas enclosure. A gas housing component is adapted to retain the pressurized gas cartridge in sealed fluid communication with the inlet. A valve is associated with the inlet. The valve has an actuator which, upon actuation, is adapted to release gas from the pressurized gas cartridge into the fluid passage. A piston is located adjacent the actuator of the valve. The piston is adapted to move the actuator into an open position permitting high pressure gas to pass into the fluid passage through the valve in response to a reduced gas pressure level within the fluid passage. The piston is also adapted to permit the actuator to move into a closed position in response to an increased gas pressure level within the fluid passage.

In accordance with yet another aspect of the present invention, a dispensing device for dispensing a viscous product is provided. The dispensing device includes a movable wall separating a product enclosure from a gas enclosure. The product enclosure has a dispensing orifice. A fluid passage provides fluid communication between a pressurized gas cartridge and the gas enclosure. A valve is associated with the pressurized gas cartridge. The valve has an actuator which, upon actuation, is adapted to release gas from the pressurized gas cartridge into the fluid passage. A piston is located adjacent the actuator of the valve. The piston is adapted to permit the actuator to move into a closed position in response to a relatively high pressure level within the fluid passage. A biasing member exerts a biasing force on the piston to cause the piston to move the actuator into an open position permitting high pressure gas to pass into the fluid passage through the valve in response to a relatively low pressure level within the fluid passage.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional illustration of a dispensing device in accordance with one preferred embodiment of the present invention, shown with gas flowing into the regulated pressure enclosure; and

FIG. 2 is a cross-sectional illustration of the preferred embodiment of FIG. 1, shown with the gas pressure equalized within the regulated pressure enclosure.

### DETAILED DESCRIPTION OF THE PREFERRED EMBODIMENTS

The following description of the preferred embodiment(s) is merely exemplary in nature and is in no way intended to limit the invention, its application, or uses. For example, although the regulator is described herein as preferably being a part of a dispensing device that is driven by pressurized CO₂ cartridges, the regulator may potentially be used with other devices and/or with other pressurized gas cartridges, such as aerosol containers that include a Schrader valve. A “Schrader valve” as used herein, is a valve that is biased to a closed position and opens when an extending actuator of the valve is depressed.

Additionally, as used herein, “pressurized gas cartridge” means a container that is capable of housing a material that can be dispensed from the container in the form of a pressurized gas. Thus, it is possible that the material inside the container is, at least partially, in a form that is not gaseous. Similarly, the phrase “product cartridge” as used herein, means a container capable of housing a product for shipping and/or storage and for dispensing. Thus, the term “cartridge” does not, in itself, require any specific structural configuration.

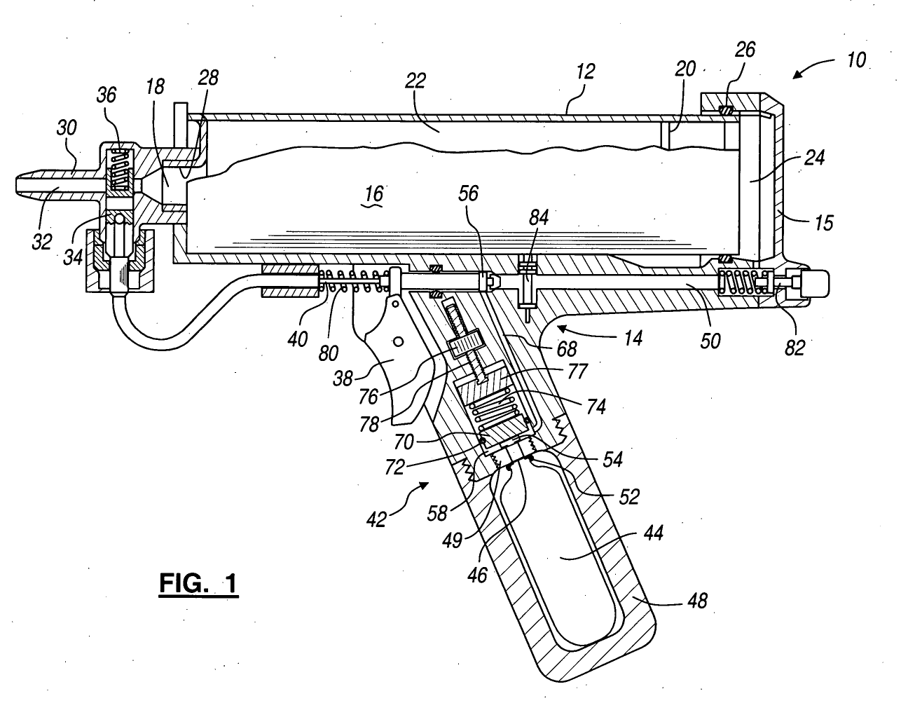

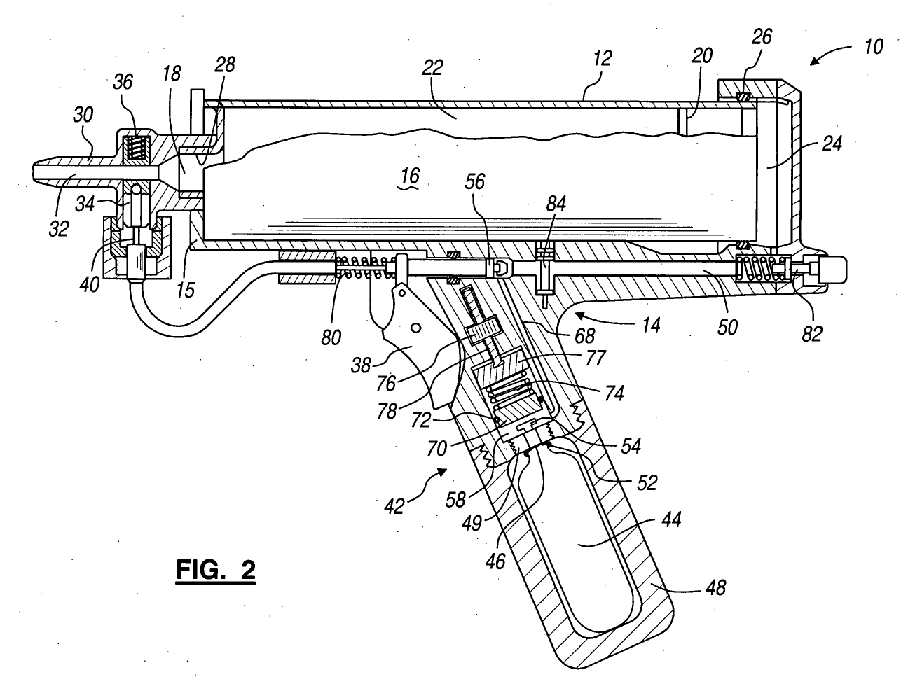

Referring to FIGS. 1 and 2, one preferred embodiment of a dispensing device 10 for dispensing a viscous product from a viscous product cartridge 12 is illustrated. The dispensing device 10 includes a housing 14. The housing 14 includes an upper portion that operates as a product cartridge housing component 15. This product cartridge housing component 15 is adapted to retain the viscous product cartridge 12. In the illustrated embodiment, the viscous product cartridge 12 is a cylindrical tubular member having a relatively rigid cylindrical wall 16. For example, the cylindrical wall 16 may be formed of cardboard or plastic. Such tubular cartridges 12 are commonly used in conjunction with or in association with construction adhesives, sealants and caulks.

At one end of such cylindrical tubular product cartridge 12 is a dispensing orifice 18. The dispensing orifice 18 may be provided, for example, by cutting the end of a nozzle (not shown) that is typically provided on many such commercially available viscous product cartridges 12. In addition, it may be necessary to rupture an internal seal (not shown) at the base of the nozzle that seals the dispensing orifice 18 and is often also included in such commercially available product cartridges 12. At the opposite end of the product cartridge 12 is a product piston 20 that seals the end of the tube 12. The product piston 20 operates as a movable wall that is capable of forcing product from the product enclosure 22 through the dispensing orifice 18 as the product piston 20 moves toward the dispensing orifice 18.

As indicated above, the upper portion of the housing 14 operates as a product cartridge housing component 15. The product cartridge housing component 15 is adapted to cooperate with the viscous product cartridge 12 to form a gas enclosure 24 separated from the product enclosure 22 by the movable product piston 20. In this embodiment, the product cartridge housing component 15 of the housing 14 is sealed to the cylindrical outer wall 16 of the product cartridge 12 using an O-ring 26 to form a gas enclosure 24 between the housing 14 and the product cartridge 12. The product piston 20 or movable wall separates the gas enclosure 24 from the product enclosure 22 formed inside the product cartridge 12.

Although this embodiment has a relatively rigid cylindrical wall 16 and a movable product piston 20, an alternative product cartridge (not shown) is made of flexible thin-film packaging material. The corresponding product cartridge housing component is modified to be sealed around the flexible side walls in this alternative embodiment providing a gas enclosure that surrounds the flexible side walls. Thus, the side walls can move toward each other under external pressure within the gas enclosure to force product through the dispensing orifice. Accordingly, the flexible thin-film side walls provide the movable walls in this alternative embodiment.

The upper portion of the housing 14 also includes a nozzle housing component 30 which is adapted to seal with a wall 28 of the product cartridge 12 that surrounds the dispensing orifice 18. As indicated above, this dispensing orifice 18 can be provided by trimming the end of a nozzle from a standard caulk or adhesive product cartridge. A rubberized gasket (not shown) may be provided between the nozzle housing component 30 and the wall 28 of the product cartridge 12 to facilitate this seal. As another possible alternative, threads (not shown) may be provided to enable threaded engagement between the wall 28 of the product cartridge 12 and the nozzle housing component 30 to facilitate the seal therebetween.

The nozzle housing component 30 includes a dispensing passage 32 which is selectively opened and closed by a valve body 34. A spring 36 biases the valve body 34 downwardly into a closed position in which the dispensing passage 32 of the nozzle housing component 30 is sealed as seen in FIG. 1. Actuation of a manually operated trigger 38 causes a cable 40 to counteract the biasing force of the spring 36 and push the valve body 34 upwardly into a dispensing or open position as see in FIG. 2. In this open position, product can be dispensed from the product cartridge 12 through the dispensing orifice 18 of the product cartridge 12 and through the dispensing passage 32 of the nozzle housing component 30.

In an alternative embodiment (not seen), the nozzle, including the valve body and dispensing passage, may be integrally provided as part of the product cartridge, rather than as part of the housing. This configuration eliminates the need for a user to seal the dispensing orifice of the product cartridge and the dispensing passage of the device housing together. In contrast, the preferred embodiment described above enables re-use of the nozzle and valve assembly with multiple disposable product cartridges.

As indicated above, a lower portion of the housing 14 of the dispensing device 10 operates as both a gas cartridge housing component and a handle 42 for manually grasping the dispensing device 10. The manually actuated trigger 38 mentioned above is associated with the handle 42. The gas cartridge housing component 42 is adapted to retain a gas cartridge 44 in sealed fluid communication with an inlet 46 that is associated with a valve 49. A fluid passage 50 provides fluid communication between the gas enclosure 24 and the inlet 46 located in the handle portion 42 of the housing 14.

Specifically, the inlet 46 of the gas cartridge 44 includes a resilient gasket seal member 52.: In addition, the inlet 46 may include a piercing member (not shown) to pierce an opening in the gas cartridge 44 upon sealing to the inlet 46. The gas cartridge housing component 42 includes a screw on housing member 48. As this housing member 48 is screwed onto the remainder of the gas cartridge housing component 42, the CO₂ gas cartridge 44 is pushed into sealing engagement with the gasket 52 of the inlet 46. In addition, screwing the housing member 48 onto the remainder of the gas cartridge housing component 42 causes any piercing member to pierce the gas cartridge 44. In any event, sealed fluid communication is provided between the interior of the gas cartridge 44 and the fluid passage 50.

In this embodiment, the valve 49 associated with the inlet 46 is a standard Schrader valve. Such valves are quite well known to those skilled in the art and, therefore, the complete structural details of the valve 49 have not been illustrated in the drawings. In brief, the Schrader valve includes a valve stem 54 which operates as an actuator that, when depressed, opens the valve 49 to allow gas to pass through the valve 49. This position of the stem 54 as illustrated in FIG. 1 corresponds to an open position of the valve 49. When the valve stem 54 is released, it is biased to move outwardly into a closed position that prevents gas from passing through the valve 49. This position of the stem 54 or actuator corresponds to a closed position of the valve 49 and is illustrated in FIG. 2.

The overall fluid passage 50 and the gas enclosure 24 define a regulated gas pressure enclosure; at least when the gas flow control valve 56 is in an open position. The overall fluid passage 50 includes a passage through the Schrader valve 49 and the initial cavity 58 into which gas exiting the Schrader valve 49 flows. In addition, the overall fluid passage includes bore 68 through which gas exits this initial cavity 58 and flows to the gas flow control valve 56. The overall fluid passage 50 then extends to the gas enclosure 24.

A piston 70 defines one wall of the initial cavity 58 and is opposed and adjacent to the valve stem 54. An O-ring 72 seals the piston 70 to the gas cartridge housing component 42 of the housing 14. A spring 74 contacts against an adjustment plug 77 and biases the piston 70 toward the valve stem 54. The adjustment plug 77 is adjusted by turning a thumbscrew 76 that is threadingly connected to a threaded rod 78. As the thumbscrew 76 is rotated, the threaded rod 78 moves axially to push the adjustment plug 77 toward or away from the piston 70. Thus, the adjustment plug 77 provides an adjustment mechanism, and its operation is discussed hereinafter.

Upon inserting the CO₂ cartridge 44 into the housing 14 and threading the screw-on housing member 48 to the remainder of the gas cartridge housing component 42, the cartridge 44 is sealed to the inlet 46 of the valve 49. In addition, the biasing force of the spring 74 initially tends to cause the piston 70 to move the valve stem 54 to open the valve 49. Pressure within the initial cavity 58 increases as gas flows into the initial cavity 58 which is part of the regulated gas pressure enclosure. This flow of gas into the initial cavity 58 from the high pressure CO₂ cartridge 44 causes the pressure inside the initial cavity 58 to increase.

As pressure within the initial cavity 58 increases, the gas pressure therein generates a force that acts upon the face of the piston 70 tending to push the piston 70 outwardly against the spring 74. Eventually, this force on the face of the piston 70 will become sufficiently large that it will counteract the biasing force of the spring 74 and the piston 70 will move away from the valve 49. A spring member (not seen) that acts on the valve stem 54 to bias the valve stem 54 to a closed position may combine with the force created by the gas pressure in the initial cavity 58 to counteract the biasing force of the spring 74 on the piston 70. Alternatively, the force generated by the gas pressure alone may be sufficient to move the piston 70 completely out of contact with the valve 49 as seen in FIG. 2.

The adjustment plug 77 can be adjusted to control the amount of gas pressure required to overcome the biasing force of the spring 74 and to permit the valve stem 54 to move and close the valve 49. Specifically, the further the adjustment plug 77 is moved toward piston 70, the greater the force required on the face of the piston 70 to cause the piston 70 to move sufficiently to permit the valve 49 to close. Thus, the further the adjustment plug 77 is moved toward piston 70, the greater the pressure level that will be achieved within the initial cavity 58 before the valve 49 closes. In contrast, moving the adjustment plug 77 away from piston 70 reduces the pressure level that will be achieved within the initial cavity before the valve 49 closes.

Rotating the thumbwheel 76 moves the threaded rod 78 axially to cause the adjustment plug 77 to move toward or away from the piston 70, depending upon the direction of rotation of the thumbwheel 76. Accordingly, the thumbwheel 76 is a manually adjustable threaded member of an adjustment mechanism that includes the threaded rod 78 and the adjustment plug 77. Thus, the user can adjust the regulated pressure level depending upon the product being dispensed.

A gas flow control valve 56 is also located along the fluid passage 50. The gas flow control valve 56 is biased to a closed position by a spring 80. The trigger 38 is used to manually actuate the gas flow control valve 56 to move the valve 56 to an open position. In the open position, gas is permitted to travel along the passage 50 from the pressurized CO₂ cartridge 44 to the gas enclosure 24. The resulting increase in gas within the gas enclosure 24 causes the pressure to increase until the product piston 20 begins to move.

As indicated above, the trigger 38 is also connected to the nozzle valve 34 to open the valve upon manual actuation. Thus, in this embodiment, the nozzle valve 34 and the gas flow control valve 56 are simultaneously opened as seen in FIG. 2. As the product piston 20 begins to move, the volume of the gas enclosure 24 expands, reducing the volume of the product enclosure 22 and dispensing product from the dispensing passage 32. Upon release of the trigger 38, both the discharge valve 34 and the gas flow valve 56 move to their closed positions as seen in FIG. 1. Thus, the product within the product enclosure 22 is maintained under pressure due to the remaining gas pressure within the gas enclosure 24. Product does not continue to be dispensed, however, due to the valve 34 of the dispensing passage 32 being in a closed position.

During the dispensing operation, the increase in size of the gas enclosure 24 causes the pressure level within the overall regulated gas pressure enclosure, including the initial cavity 58, to fall. If the pressure level falls sufficiently, then the biasing force of the spring 74 acting upon the piston 70 again causes the piston 70 to push the valve stem 54 to open the valve 49 as seen in FIG. 1. Once again, gas flows into the initial cavity 58 until the pressure therein increases sufficiently enough to cause the piston 70 to move away from the valve 49 against the biasing force of the spring 74; thereby permitting the valve 49 to close. Thus, the biased piston 70, valve 49 and the regulated gas pressure enclosure, including the initial cavity 58, function as a pressure regulator.

The pressure regulator is located within the fluid passage 50. The pressure regulator reduces the pressure of the pressurized CO₂ gas flowing from the pressurized CO₂ cartridge 44 to a lower pressure level. This lower level of pressure is high enough to drive product from the product cartridge 12 at a desirable rate. Thus, the pressure regulator receives gas at a relatively high pressure level at the inlet 46 and converts the gas to a reduced pressure level that is desirable for use in the gas enclosure 24.

Two additional valve mechanisms are located within the fluid passage in this embodiment. One is a pressure release valve 82 that is additionally associated with the gas enclosure 24 and is biased to a closed position. The pressure release valve 82 may be manually moved to an open position to permit the release of pressure from the gas enclosure 24. This release of pressure can, for example, facilitate the replacement of the viscous product cartridge 12. A maximum pressure release valve 84 is also included in the fluid passage 50 that is designed to vent the CO₂ gas from the gas enclosure 24 should the pressure therein exceed a maximum pressure level.

Operation of the dispensing device 10 involves locating a product cartridge 12 in the product cartridge retaining housing component 15. As described above, this creates a gas enclosure 24 separated from a product enclosure 22 by a moveable wall 20. In addition, operation of the dispensing device 10 involves locating a CO₂ cartridge 44 inside the gas cartridge retaining housing component 42. This is accomplished by screwing on housing member 48 to the remainder of the gas cartridge housing component 42.

Manually actuating the trigger 38 causes opening of both the nozzle valve 34 and gas flow control valve 56. Pressurized gas from the CO₂ cartridge 44 flows through the components forming the pressure regulator (including valve 49, piston 70, spring 74 and initial cavity 58) where the pressure of the gas is reduced to an operational pressure as described above. This pressure is selected to affect a desirable dispensing rate without unnecessarily increasing the pressure. A typical operational pressure is from about 20 to about 50 psi. As discussed above, the adjustment plug 77 allows the user to adjust the regulated pressure level to accommodate various products and dispensing rates.

The pressurized gas flows past the open gas flow control valve 56 in the fluid passage 50 and into the gas enclosure 24. As the quantity of gas in the gas enclosure 24 increases, the gas begins to push against the product piston 20. Since the nozzle valve 34 is open, the product piston 20 begins to move, thereby increasing the volume of the gas enclosure 24. Conversely, this movement of the product piston 20 decreases the volume of the product enclosure 22. Thus, product is pushed from the product enclosure 22 through the dispensing orifice 18 and the open nozzle valve 34 in the dispensing passage 32. Upon release of the trigger 38, the gas flow control valve 56 closes to cause the flow of gas from the CO₂ cartridge 44 to the gas enclosure 24 to cease. In addition, the product valve 34 in the nozzle housing component 30 closes, which causes the flow of product through the dispensing passage 32 to cease.

Only a small number of the many possible alternatives are described above. Many additional modifications and alternatives beyond those described above, may be envisioned by those skilled in the art. For example, as illustrated herein, the Schrader valve is associated with the inlet of the fluid passage as a result of being located within the fluid passage. In an alternative embodiment, the pressurized gas cartridge includes the Schrader valve. Thus, the Schrader valve is associated with the inlet of the fluid passage when the pressurized gas cartridge is associated with the inlet.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A pressure regulator comprising:
a regulated pressure gas enclosure;
a valve associated with a source of high pressure gas, the valve having an actuator that, when depressed, releases high pressure gas from the source into the regulated pressure gas enclosure;
a piston located adjacent the actuator of the valve, the piston being adapted to move the actuator into an open position permitting high pressure gas to pass into the regulated gas pressure enclosure through the valve in response to a reduced gas pressure level in the regulated pressure gas enclosure, and the piston being adapted to permit the actuator to move into a closed position in response to an increased gas pressure level within the regulated pressure gas enclosure.

2. A pressure regulator according to claim 1, wherein an adjustment mechanism is associated with the piston to adjust the increased gas pressure level within the regulated gas enclosure at which the piston permits the actuator to move into a closed position.

3. A pressure regulator according to claim 2, wherein the adjustment mechanism comprises a manually adjustable threaded member.

4. A pressure regulator according to claim 1, wherein a spring exerts a biasing force against the piston.

5. A pressure regulator according to claim 1, wherein the valve is a separate component from the source of high pressure gas.

6. A pressure regulator according to claim 1, wherein the source of high pressure gas is a pressurized gas cartridge.

7. A pressure regulator according to claim 1, wherein the regulated pressure gas enclosure is at least partially defined by a movable wall.

8. A device for dispensing a viscous product from a viscous product cartridge, the dispensing device being adapted to be driven by a pressurized gas cartridge, the dispensing device comprising:
a product housing component adapted to retain the viscous product cartridge and to cooperate with the viscous product cartridge to form a gas enclosure separated from a product enclosure by a movable wall;
a fluid passage providing fluid communication between an inlet and the gas enclosure;
a gas housing component adapted to retain the pressurized gas cartridge in sealed fluid communication with the inlet; and
a valve associated with the inlet, the valve having an actuator which, upon actuation, is adapted to release gas from the pressurized gas cartridge into the fluid passage;
a piston located adjacent the actuator of the valve, the piston being adapted to move the actuator into an open position permitting high pressure gas to pass into the fluid passage through the valve in response to a reduced gas pressure level in the fluid passage, and the piston being adapted to permit the actuator to move into a closed position in response to an increased gas pressure level within the fluid passage.

9. A device for dispensing a viscous product according to claim 8, wherein a spring exerts a biasing force against the piston.

10. A device for dispensing a viscous product according to claim 8, wherein an adjustment mechanism is associated with the piston to adjust the increased gas pressure level within the regulated gas enclosure at which the piston permits the actuator to move into a closed position.

11. A device for dispensing a viscous product according to claim 10, wherein the adjustment mechanism comprises a manually adjustable threaded member.

12. A device for dispensing a viscous product according to claim 8, wherein the valve is a separate component from the source of high pressure gas.

13. A combination including a device for dispensing a viscous product according to claim 12, and further comprising the pressurized gas cartridge.

14. A combination including a device for dispensing a viscous product according to claim 13, wherein the pressurized gas cartridge is a CO₂ gas cartridge.

15. A dispensing device for viscous product, comprising;
a movable wall separating a product enclosure having a dispensing orifice from a gas enclosure;
a fluid passage providing fluid communication between a pressurized gas cartridge and the gas enclosure;
a valve associated with the pressurized gas cartridge, the valve having an actuator which, upon actuation, is adapted to release gas from the pressurized gas cartridge into the fluid passage;
a piston located adjacent the actuator of the valve, the piston being adapted to permit the actuator to move into a closed position in response to a relatively high pressure level within the fluid passage;
a biasing member exerting a biasing force on the piston to cause the piston to move the actuator into an open position permitting high pressure gas to pass into the fluid passage through the valve in response to a relatively low pressure level within the fluid passage.

16. A device for dispensing a viscous product according to claim 15, wherein a spring exerts a biasing force against the piston.

17. A device for dispensing a viscous product according to claim 15, wherein an adjustment mechanism is associated with the piston to adjust the relatively high pressure level at which the actuator is permitted to move into a closed position.

18. A device for dispensing a viscous product according to claim 17, wherein the adjustment mechanism comprises a manually adjustable threaded member.

19. A device for dispensing a viscous product according to claim 15, wherein the pressurized gas cartridge is a CO₂ gas cartridge.

20. A device for dispensing a viscous product according to claim 19, wherein the CO₂ gas cartridge is located in the fluid passage.
